(19) United States
(12) Patent Application Publication
(10) Pub. No.: US 2006/0058080 A1
(43) Pub. Date: Mar. 16, 2006

(54) Demountable strapping module and handheld electronic device utilizing the same

(75) Inventor: Chih-Jen Chen, Taipei City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/224,116

(22) Filed: Sep. 13, 2005

(30) Foreign Application Priority Data
Sep. 15, 2004 (TW) 93127846

(51) Int. Cl. H04M 1/00; A45F 5/02

(52) U.S. Cl. 455/575.6; 224/930; 24/3.13

(57) ABSTRACT

A demountable strapping module for a handheld electronic device. A latch element engages a strapping element, and a strap winds around the engaged strapping element. The strapping element with the strap and the latch element are inserted into the handheld electronic device. Thus, it is convenient for a strap to attach to a handheld electronic device.

### BACKGROUND

The invention relates to a strapping module for a handheld electronic device, and in particular to a demountable strapping module for a handheld electronic device.

FIGS. 1a and 1b show a conventional handheld electronic device (a mobile phone or a personal digital assistant). The handheld electronic device has a main body 10 with two adjacent strapping cavities 20 disposed on one side thereof. A strap can pass through the strapping cavities 20 in the direction of the arrows shown in FIG. 1b and be tied to the main body 10. The strapping cavities 20 must be limited in size for design considerations, and most straps are made of soft material to hinder passage of the strap through the strapping cavities 20.

### SUMMARY

A demountable strapping module according to an embodiment of the invention comprises a strapping element for a strap and a latch element engaging the strapping element and inserted into the opening therewith. The strapping element comprises at least one column and the latch element comprises at least one latch portion comprising a groove engaging the column.

### BRIEF DESCRIPTION OF THE DRAWINGS

The invention can be more fully understood by reading the subsequent detailed description and examples with references made to the accompanying drawings, wherein:

FIG. 1a is a perspective view of a conventional handheld electronic device;

FIG. 1b is a perspective view of strapping cavities of a conventional handheld electronic device;

FIGS. 2a, 2b, 2c are perspective views of a strapping module and a handheld electronic device according to an embodiment of the invention;

FIG. 3 is an exploded perspective view of a strapping module according to an embodiment of the invention;

FIG. 4 is another exploded perspective view of a strapping module according to an embodiment of the invention;

FIG. 5 is a perspective view of a strapping module according to an embodiment of the invention;

FIG. 6 is a schematic view showing a strapping module prior to combination with a handheld electronic device according to an embodiment of the invention;

FIGS. 7a-7d are schematic views showing a strapping module combined to a handheld electronic device according to an embodiment of the invention.

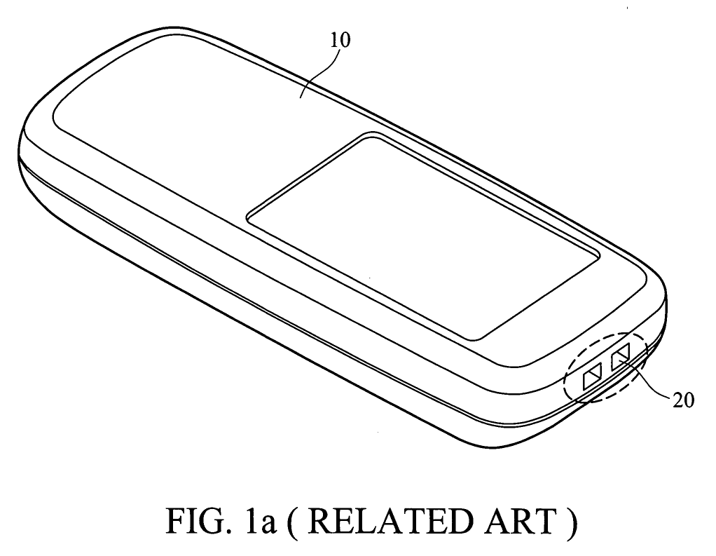

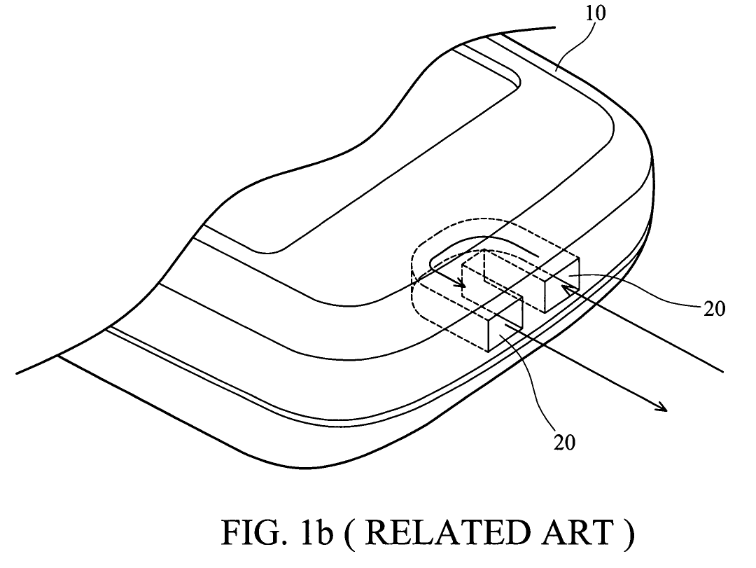

### DETAILED DESCRIPTION

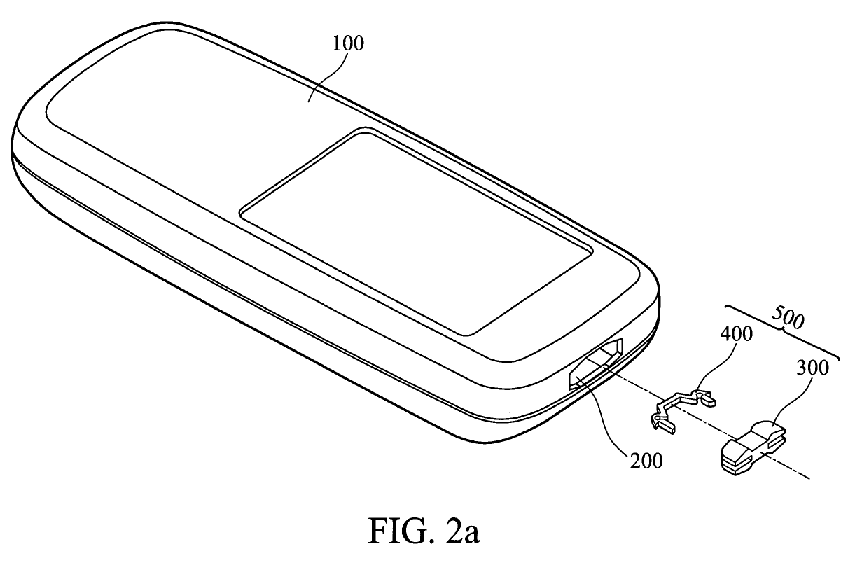

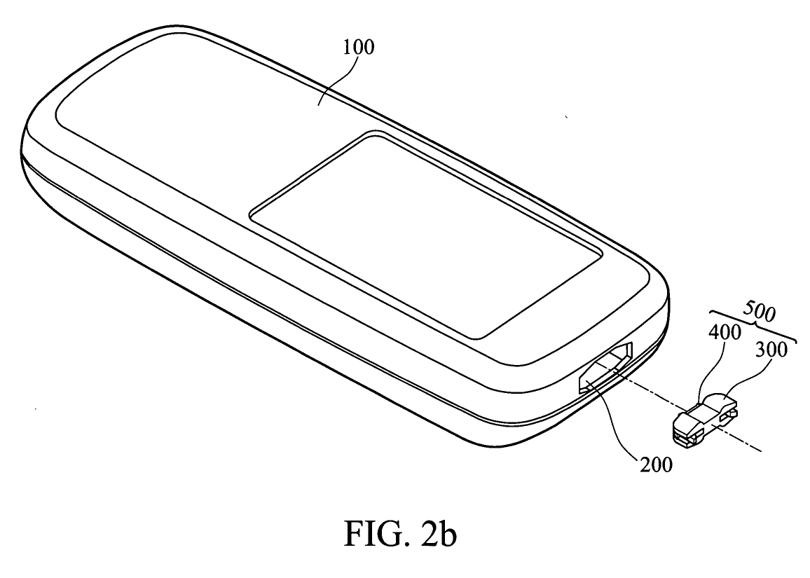

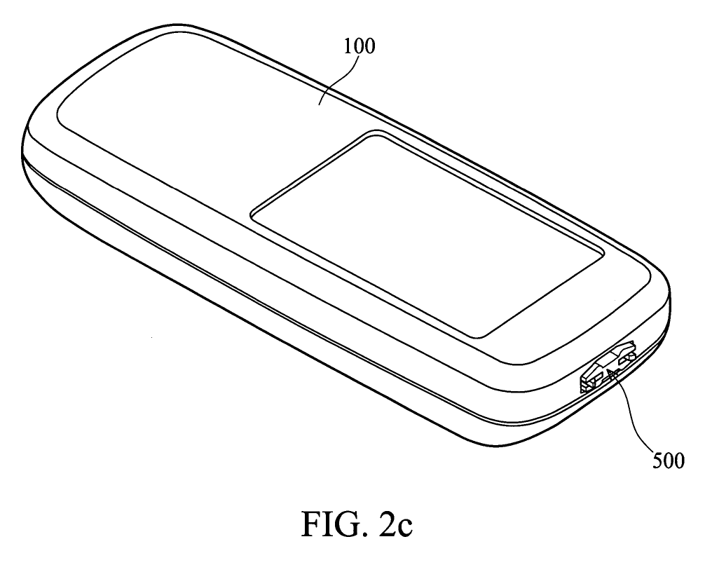

An embodiment of a handheld electronic device is a mobile phone. Referring to FIG. 2a, 2b and 2c, a mobile phone comprises a main body 100 and an opening 200 defined on the main body 100. A strapping module 500 comprises a strapping element 300 and a latch element 400 capable of engaging the strapping element 300. As shown in FIG. 2b and 2c, the strapping module 500 with a strap (not shown) wound therearound is inserted into the opening 200.

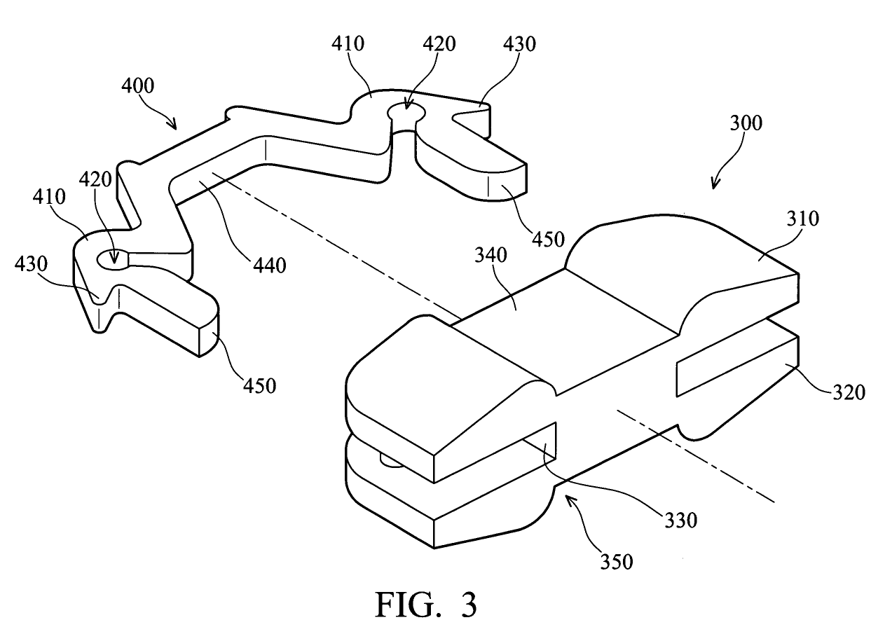

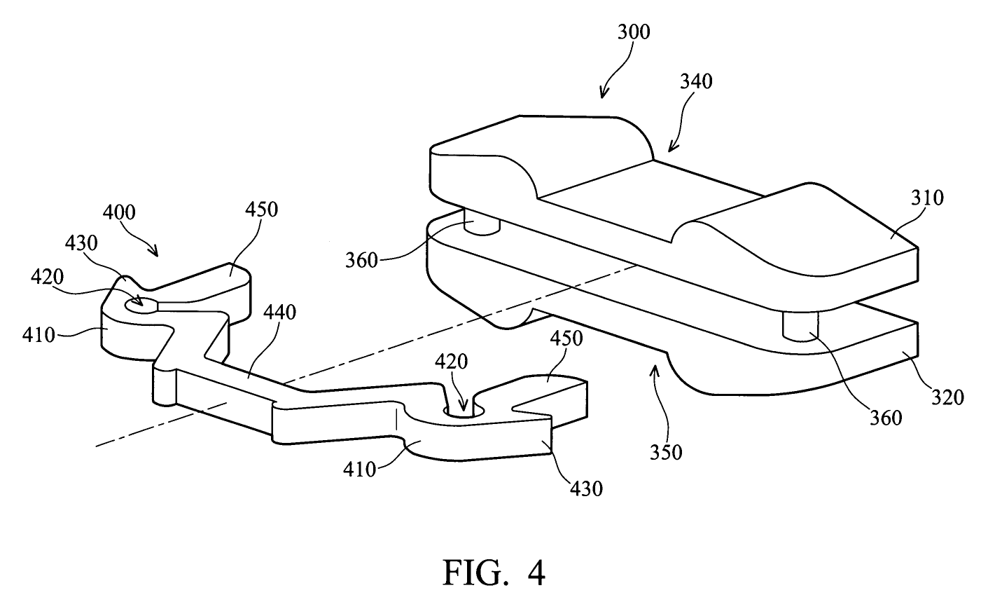

FIGS. 3 and 4 are perspective views of the strapping 300 and the latch element 400. The strapping element 300 comprises a first portion 310, a second portion 320 opposite and parallel to the first portion 310, and a connection portion 330 connecting the first and second portions 310 and 320, configured in a substantially I shaped. Two cylinders 360 are disposed between the first and second portions 310 and 320 and positioned on two opposite sides of the connection portion 330. Depressions 340 and 350 are defined on the first and second portions 310 and 320 respectively for winding the strap therearound.

As shown in FIGS. 3 and 4, the latch element 400 comprises two symmetrical latch portions 410 connected with a middle portion 440. Each latch portion comprises a circular groove 420 corresponding to the cylinder 360, a hook 430 protruding therefrom, and a finger 450 adjacent to the hook 430 extending therefrom. The finger 450 is also adjacent to the groove 420.

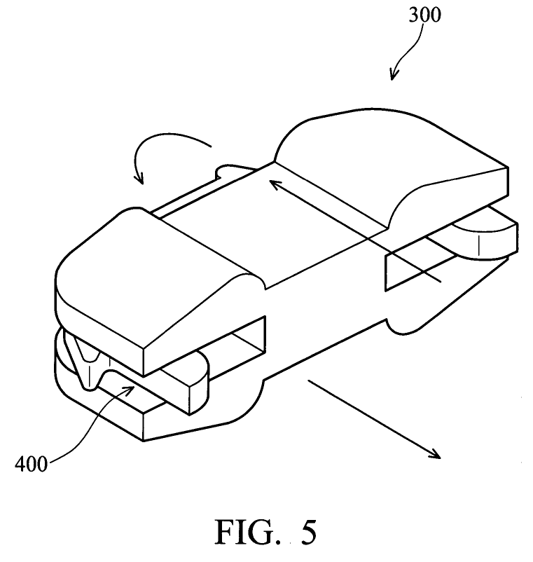

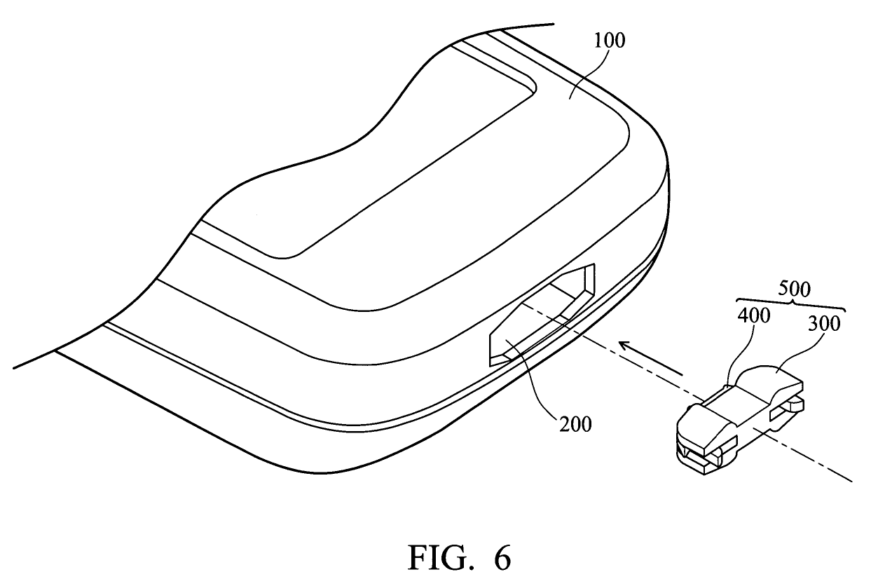

When the strapping element 300 engages the latch element 400, as shown in FIG. 5, the groove 420 engages the cylinder 360, and the root of the finger 450 latches the cylinder 360 so that the latch element 400 tightly joins the strapping element 300. A strap winds around the first and second depressions 310 and 320 and the middle portion 440 in the direction of the arrow and is temporarily attached to the strapping module 500. As shown in FIG. 6, the strap and the strapping module 500 are inserted into the opening 200.

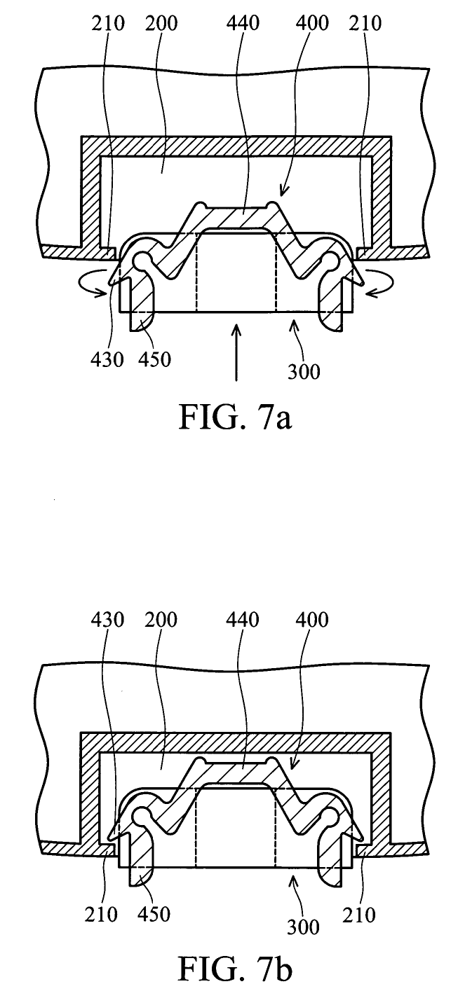

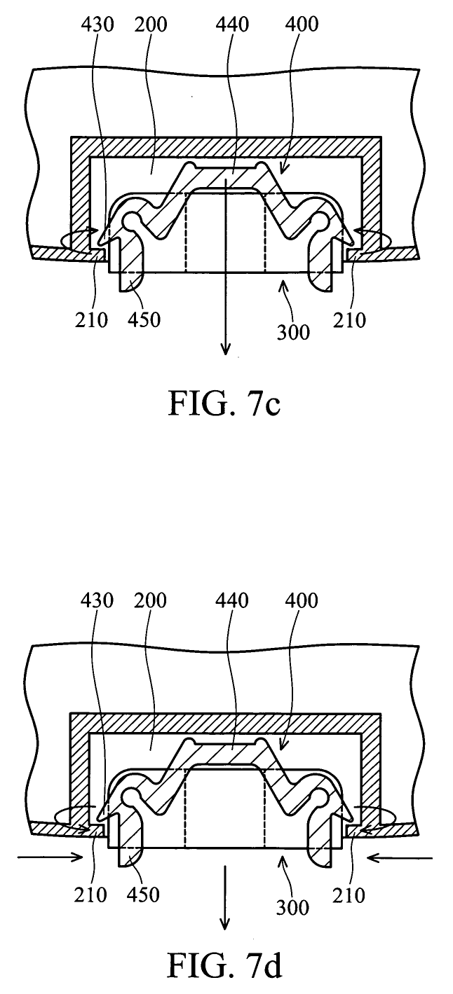

Referring to FIG. 7a, a flange 210 is disposed on the inner wall of the opening 200. When the latch element 400 is inserted into the opening 200, the finger 450 is pushed inward to deform the latch element 410 so as to enter the opening 200 smoothly. When the hook 430 passes the flange 210, the finger 450 is released to latch the hook 450 with the flange 210 and partially extends out of the opening 200, as shown in FIG. 7b. Referring to FIG. 7c, when the strap is pulled, force is exerted on the middle portion 440 to make the latching potions 410 stretch out, thereby the hook 430 latches the flange 210 more securely and the strapping module 500 engages the main body 100 more securely. When the strapping module 500 is to be demounted, as shown in FIG. 7d, the finger 450 is pressed inward to release the hook 430 from the flange 210, and the strapping module is removed from the main body 100.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A demountable strapping module for a handheld electronic device with an opening, comprising:
a strapping element for a winding strap therearound; and
a latch element engaging the strapping element and inserted into the opening therewith.

2. The demountable strapping module as claimed in claim 1, wherein the strapping element comprises at least one column and the latch element comprises at least one latch portion comprising a groove engaging the column.

3. The demountable strapping module as claimed in claim 2, wherein the strapping element further comprises a first portion, a second portion opposite the first portion, and a connection portion connecting the first and second portions, and the column is disposed between the first and second portions.

4. The demountable strapping module as claimed in claim 3, wherein the column is a cylinder.

5. The demountable strapping module as claimed in claim 3, wherein the strapping element is substantially I-shaped.

6. The demountable strapping module as claimed in claim 3, wherein the strapping element further comprises a first depression on the first portion and a second depression on the second portion for the winding strap therearound.

7. The demountable strapping module as claimed in claim 2, wherein the latch element further comprises at least one hook protruding from the latch portion, and making the strapping element and the latch element engage the opening.

8. A handheld electronic device, comprising:
a main body;
an opening on the main body and comprising an inner wall;
a strapping element for a strap; and
a latch element engaging the strapping element and inserted into the opening therewith.

9. The handheld electronic device as claimed in claim 8, wherein the strapping element comprises at least one column and the latch element comprises at least one latch portion comprising a groove engaging the column.

10. The handheld electronic device as claimed in claim 9, wherein the strapping element further comprises a first portion, a second portion opposite the first portion, and a connection portion connecting the first and second portions, and the column is disposed between the first and second portions.

11. The handheld electronic device as claimed in claim 10, wherein the column is cylindrical.

12. The handheld electronic device as claimed in claim 10, wherein the strapping element is substantially I-shaped.

13. The handheld electronic device as claimed in claim 10, wherein the strapping element further comprises a first depression on the first portion and a second depression on the second portion for winding the strap therearound.

14. The handheld electronic device as claimed in claim 9 further comprising a flange protruding from the inner wall of the opening, wherein the latch element comprises a hook extending from the latch element and making the strapping element and the latch element engages the opening.
